(19) United States
(12) Patent Application Publication
(10) Pub. No.: US 2008/0084836 A1
(43) Pub. Date: Apr. 10, 2008

(54) Low power wireless communication method

(75) Inventors: Leemon C. Baird, Colorado Springs, CO (US); Mance E. Harmon, Cedar Park, TX (US); John Hughes, San Jose, CA (US)

Correspondence Address: LAW OFFICE OF DALE B. HALLING, LLC, 655 SOUTHPOINTE CT, SUITE 100, COLORADO SPRINGS, CO, 80906, US

(73) Assignee: BlueWave Security, Inc.

(21) Appl. No.: 11/906,809

(22) Filed: Oct. 4, 2007

Related U.S. Application Data
(60) Provisional application No. 60/849,356, filed on Oct. 4, 2006.

(51) Int. Cl. G08C 17/00

(52) U.S. Cl. 370/311

(57) ABSTRACT

A low power wireless communication method has a remote device with a simple receiver that listens for a wake-up signal. When the wake-up signal is received a complex receiver is turned on to communicate with the control device. In another embodiment, the simple receiver powers up periodically (or aperiodically) to listen for the wake-up signal.

In addition, a wireless modem can communicate to a device, such as an electronic lock, in a number of modes to save power. In one mode the wireless modem just passes any incoming messages through to the device in real time. However, if power needs to be conserved incoming messages can be saved in cache and forwarded to the device over a low power bus, such as a serial bus. In another embodiment, the incoming message can be filtered to determine if it needs to be forwarded to the device.

### RELATED APPLICATIONS

The present invention claims priority on provisional patent application Ser. No. 60/849,356, filed on Oct. 4, 2006, entitled “Communication Strategy for Low-Power Wireless Communication”, and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

There is a continuing trend to replace wired devices with wireless devices. However providing power for these wireless devices is a continuing problem. In one common situation there is often a need for a wireless device to conserve energy, yet to receive messages from other devices. This problem particularly arises in the area of wireless security devices. Using wireless security devices that have to have batteries replaced often or require a power wire significantly reduces the attractiveness of these devices to the consumer. Thus there exists a need for a low-power wireless communication system.

### BRIEF SUMMARY OF INVENTION

The invention relates to a low power wireless communication method has a remote device with a simple receiver that listens for a wake-up signal. The wake-up signal may just be a single frequency signal. When the wake-up signal is received a complex receiver is turned on to communicate with the control device. In another embodiment, the simple receiver powers up periodically (or aperiodically) to listen for the wake-up signal.

In another embodiment, a wireless modem can communicate to a device, such as an electronic lock, in a number of modes to save power. In one mode the wireless modem just passes any incoming messages through to the device in real time. However, if power needs to be conserved incoming messages can be saved in cache and forwarded to the device over a low power bus, such as a serial bus. In another embodiment, the incoming message can be filtered to determine if it needs to be forwarded to the device.

In another embodiment, the low power communication method determines if an aperiodic event occurs. When an aperiodic event occurs a receiver wakes up at the remote device and listens for a message waiting signal from a control point. If a message is waiting it can be transmitted to the remote device.

### BRIEF DESCRIPTION OF THE SEVERAL VIEWS OF THE DRAWINGS

FIG. 1 is a block diagram of a wireless communication system in accordance with one embodiment of the invention;

FIG. 2 is block diagram of a wireless communication system in accordance with one embodiment of the invention;

FIG. 3 is a block diagram of a receiver system for a remote device in accordance with one embodiment of the invention;

FIG. 4 is a block diagram of a wireless modem and a remote device in accordance with one embodiment of the invention;

FIG. 5 is a flow chart of the steps used in a low power wireless communication method;

FIG. 6 is a flow chart of the steps used in a low power wireless communication method; and

FIG. 7 is a flow chart of the steps used in a low power wireless communication method.

### DETAILED DESCRIPTION OF THE INVENTION

The invention relates to a low power wireless communication method has a remote device with a simple receiver that listens for a wake-up signal. The wake-up signal may just be a single frequency signal. When the wake-up signal is received a complex receiver is turned on to communicate with the control device. In another embodiment, the simple receiver powers up periodically (or aperiodically) to listen for the wake-up signal.

In another embodiment, a wireless modem can communicate to a device, such as an electronic lock, in a number of modes to save power. In one mode the wireless modem just passes any incoming messages through to the device in real time. However, if power needs to be conserved incoming messages can be saved in cache and forwarded to the device over a low power bus, such as a serial bus. In another embodiment, the incoming message can be filtered to determine if it needs to be forwarded to the device.

In another embodiment, the low power communication method determines if an aperiodic event occurs. When an aperiodic event occurs a receiver wakes up at the remote device and listens for a message waiting signal from a control point. If a message is waiting it can be transmitted to the remote device.

These methods either together or alone provide a low-power wireless system that extends the life of batteries used to power remote devices.

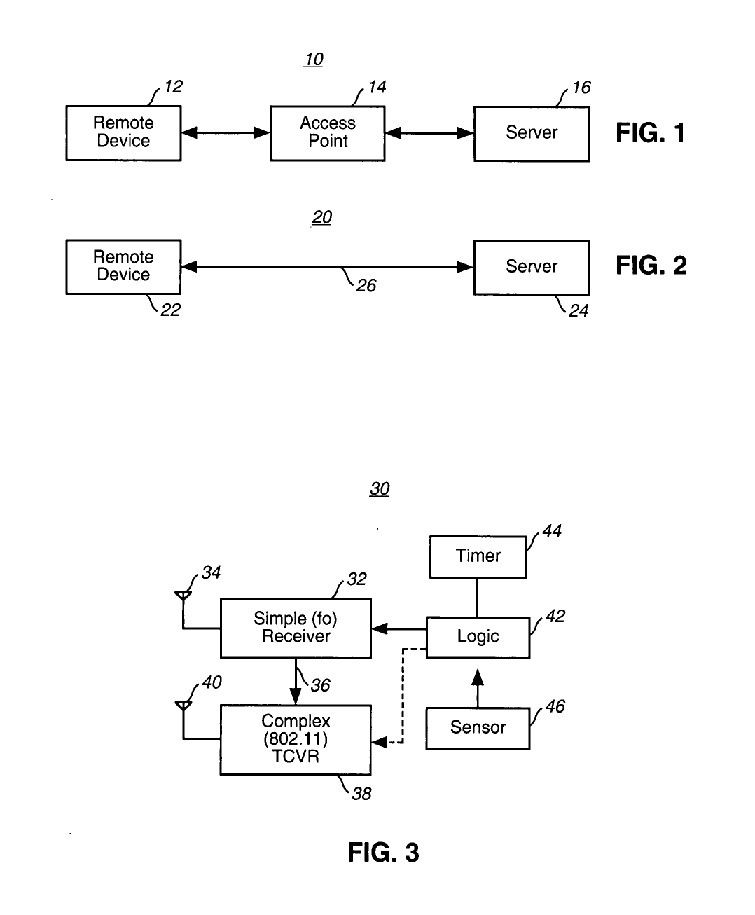

FIG. 1 is a block diagram of a wireless communication system 10 in accordance with one embodiment of the invention. A system 10 has a remote device 12 which generally does not have access to a power line and therefore runs off of batteries. The remote device 12 communicates wirelessly with an access point 14. Note that the access point usually does have access to a power line. The access point 14 communicates with a server 16. The communication link between the access point 14 and the server 16 may be over a cable or may be wireless. The server 16 has access to a power line. The access point 14 and the server 16 together may be called a control point or the server 16 by itself may be referred to as the control point.

FIG. 2 is block diagram of a wireless communication system 20 in accordance with one embodiment of the invention. This system 20 is similar to that shown in FIG. 1 except that there is no access point. As a result, the remote device 22 communicates directly with the server 24 over wireless link 26. In one embodiment, the remote device is a security device such as a lock.

FIG. 3 is a block diagram of a receiver system 30 for a remote device in accordance with one embodiment of the invention. The remote device is assumed to be an intelligent device and would receive and transmit messages to the receiver system 30. The receiver system 30 has a simple receiver 32 with an antenna 34. The simple receiver 32 passes a wake-up signal over channel 36 to a complex transceiver 38. The complex transceiver 38 is a 802.11 wireless receiver in one embodiment. The complex transceiver 38 has an antenna 40. Note that in one embodiment, the antennas 34 and 40 may be a single antenna. A logic system 42 may be coupled to the simple receiver 32 and/or to the complex transceiver 38. The logic system 42 may be coupled to a timer 44 and may be coupled to a sensor 46. In one embodiment of the invention, the simple receiver 32 is designed to receive a single frequency signal and therefore may just be a energy detecting receiver. This simple receiver 32 requires significantly less power than the complex receiver 38. When the simple receiver 32 detects a wake-up signal from the access point or server, hereinafter control point, it sends a wake-up signal to the complex transceiver 38. The complex transceiver 38 then starts a dialog with the control point. Once the dialog is done or a certain period of time with no communication occurs the complex transceiver 38 powers down.

In another embodiment, the simple receiver 32 is not powered at all times. In this case an aperiodic event is used to turn on the simple receiver 32 for a certain period of time to listen for the wake-up signal. In one embodiment, the timer 44 and logic 42 are used to generate a random time interval after which the simple receiver 32 is then powered up. In another embodiment, the logic 42 and the sensor 46 are used to generate an aperiodic event. For example, the sensor may be a light sensor and when the lights turn off the simple receiver 32 is turned on to listen for the wake-up signal. In another example, the logic 42 may be used to select a certain number of times the lights are turned on and off. The sensor 46 may detect the number of times a door is opened or the number of times a lock is used or any number of other random events. In another embodiment, the receiver system may not have a simple receiver 32 and a complex transceiver 38, but may just have a single transceiver that is powered up occasionally by an aperiodic event generated by the logic system 42 and timer 44 or sensor 46.

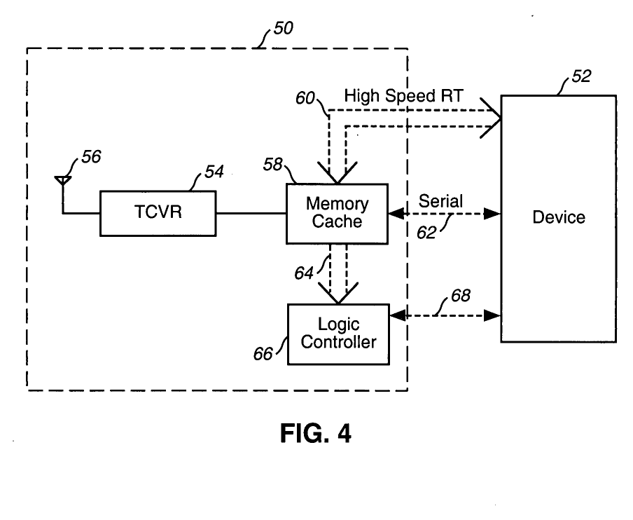

FIG. 4 is a block diagram of a wireless modem 50 and a remote device 52 in accordance with one embodiment of the invention. The wireless modem 50 has a transceiver 54 coupled to an antenna 56. The transceiver 54 is coupled to a memory cache 58. The memory cache 58 can be connected to the intelligent remote device 52 by any of a number of communication paths. One path is a high speed real-time bus 60. In one embodiment, the high speed real-time bus 60 is coupled directly between the transceiver 54 and the device 52 bypassing the memory cache 58. A second communication path 62 is a low speed low power non-real time communication bus, such as a serial bus. A third communication path 64 first connects with a logic controller 66 that filters the information. The logic controller 66 is connected by another bus 68 to the device 52.

In one embodiment, the wireless modem 50 implements the power saving protocol of 802.11. In the 802.11 standard, the Power Saving Protocol (PSP) allows a wireless device to tell the access point (AP) that it is a low-power device. After that, if the access point receives a packet addressed to that device, it will hold that message in a buffer for up to 15 seconds, and broadcast a beacon signal. The device wakes up periodically (e.g. every 14 seconds) and listens for the beacon. If the beacon signal is detected, it then contacts the AP and requests that the packet be sent. In this way, a device can sleep most of the time, only actively listening once every 15 second. Once the wireless modem 50 receives the message it can forward the message to the device 52 over any of the communication paths. If saving power is the most important factor then any received messages can be first stored in the memory cache. Then with the transceiver powered down, the message can be transferred to the device 52 over the low-power communication path 62 in a non-real time manner. This saves a significant amount of power. Alternatively, the message can first be filtered by the logic controller 66 and only passed to the device 52 if action is necessary. Finally, if speed is important then the high speed parallel bus 60 may be used to pass the message to the device 52.

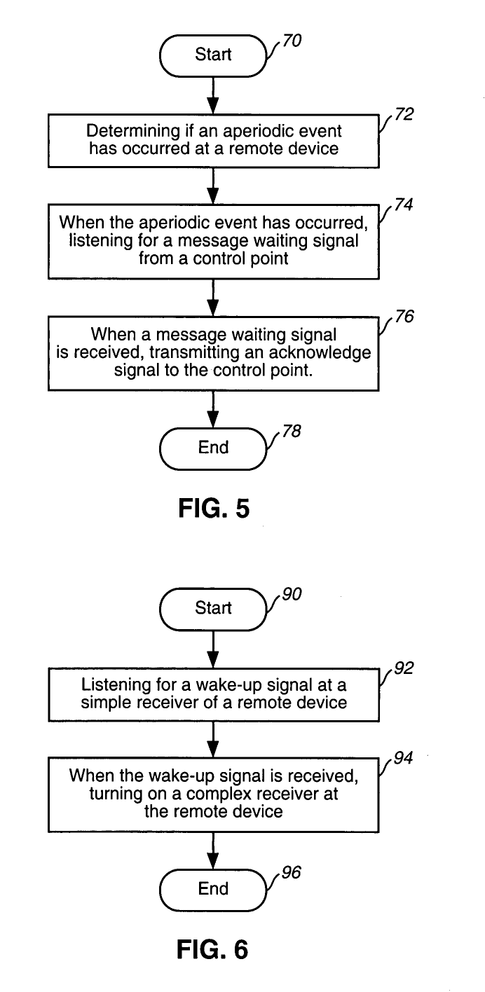

FIG. 5 is a flow chart of the steps used in a low power wireless communication method. The method starts, step 70, by determining if an aperiodic event has occurred at a remote device at step 72. When the aperiodic event has occurred, the control point listens for a message waiting signal at step 74. When a message waiting signal is received, an acknowledge signal is transmitted at step 76 to the control point which ends the process at step 78.

FIG. 6 is a flow chart of the steps used in a low power wireless communication method. The method starts, step 90, by listening for a wake-up signal at a simple receiver of a remote device at step 92. When the wake-up signal is received, a complex receiver is turned on at step 94 at the remote device, which ends the process at step 96.

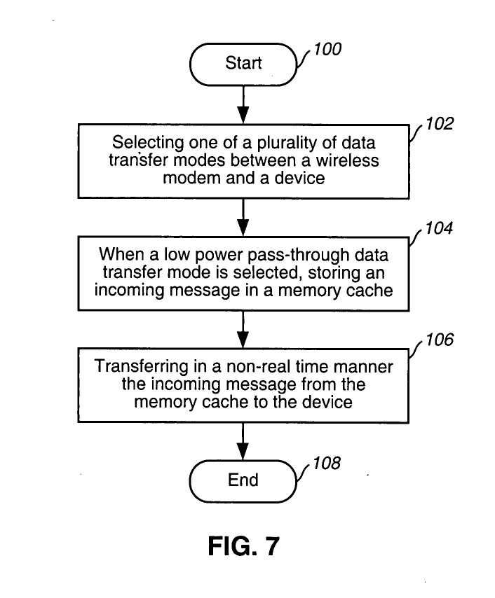

FIG. 7 is a flow chart of the steps used in a low power wireless communication method. The method starts, step 100, by selecting one of a plurality of data transfer modes between a wireless modem and a device at step 102. When a low power pass through data transfer mode is selected, an incoming message is stored in a memory cache at step 104. At step 106, the incoming message is transferred a non-real time manner from the memory cache to the device which ends the process at step 108.

The invention is direct to:
Communication in general between a server and remote device
More specifically, the remote device could be part of a security system, such as a closed circuit TV camera (CCTV), infrared motion detector, etc.
Even more specifically, the remote device could be part of an access control system, such as a door lock or proximity card reader.

The remote device wakes up periodically or aperiodically. How the protocol works is described below:
The wireless device contains both a standard 802.11 system (both hardware and software) and a supervisory system
The standard 802.11 system is turned off most of the time
The supervisory system periodically wakes up, for example once every 15 minutes or once a day.
A server that intends to communicate with the device is preconfigured to only attempt communication at certain times, when the PSP (Power Saving Protocol) system will be active.
When the supervisory system wakes up, it powers up the 802.11 system in PSP mode. The 802.11 system then performs the normal PSP protocol, which includes sleeping most of the time and waking up every 15 seconds or less to listen for the beacon.
While PSP mode is active, the system will check for waiting packets on the AP (Access Point).
After a short period of time, the supervisory system shuts down the 802.11 system, then waits until the next time to wake up.

This system can use much less power than the normal PSP system. Unlike the normal PSP protocol, it will allow packets to be lost if they are sent at the wrong time. Below are a number extensions to this system:
When the supervisor system on the wireless device is about to sleep, it may first send a message to the server telling it when, at what time, it will awaken next (or telling it at what interval it will awaken)
Each time the server and wireless device successfully communicate, the server may send the device a command giving it the next time that it should wake up into PSP mode.
In addition to the protocol above, the wireless device may be designed to wake up and send a packet when certain conditions occur. For example, a smoke detector or physical intrusion detector on a door or window may wake up the wireless device and immediately send an alarm packet when the event occurs.
The device can awaken and go into PSP mode aperiodically instead of periodically. If the timing is predictable, then the server can send packets at the correct time while it is receiving. If the timing is unpredictable, then the server can send a packet every 15 seconds until it finally receives an acknowledgement. The wireless device can awaken into PSP mode when certain events occur to trigger it. For example:
   A door lock triggers every time a user opens the door
   A door lock triggers every 2^{nd} time, or 3^{rd} time, or Nth time the user opens the door
   A device triggers every time (or every Nth time) a certain environmental change occurs, such as the lights in the room being turned on or off, or the temperature rising or falling across some threshold
   A device triggers when it receives a wireless signal that is strong enough to power it. This would be similar to Radio Frequency Identification (RFID) tags that are powered by the energy of the radio frequency signal itself. In this way, no energy needs to be expended by the wireless device while it is waiting, though it might require the transmitter to be relatively close.
   All of the 11 triggers mentioned in the provisional patent are hereby incorporated.

In addition to all of the above, the invention has three modes on its wireless modem. This is the system is described below:
There is a communication device. In one example it's a WiFi modem
There is an attached device. In one example it's a door lock
The communication device and attached device communicate through a low-power serial connection. In one example it's a wire that's only centimeters or millimeters in length.
The communication device communicates with the network in a way that uses more power than the serial connection to the attached device. In one example, WiFi uses much more power than a short serial cable.
The network connection is faster than the serial connection.
If the communication device receives a series of packets from the network, it passes them on to the attached device, which then replies, and the communication device relays those reply packets back through the network.
   There are three modes that the communication device can be in. They are:
“Passthrough mode”—the communication device simply relays all the packets in both directions. This mode uses the most power of the three modes, but doesn't require the communication device to understand anything about the packets.
“Buffered passthrough mode”—This is the same as passthrough mode, except It only turns on the WiFi long enough to receive a burst of many packets, then it is turned off during the slower process of sending those packets to the attached device and waiting for the reply packets. Then it is turned on WiFi while sending out the burst of all reply packets. This requires the communication device to know when the burst is over, so it needs a small amount of knowledge about the message traffic. It saves power by only turning on WiFi when absolutely necessary.
“Smart modem”—This is the lowest-power mode. It is the same as buffered passthrough mode, except that it filters the packets to save even more power by reducing the total amount of communication. Examples of filtering that it might do include (depending on the nature of the attached device):
   Delete reply messages that the remote server or computer does not need to see
   If it receives a burst of many messages from the network, and then receives an error message from the attached device, it can wait then resend the messages to the attached device from its buffer. This can be much better than waiting for the remote computer on the network to resend all the packets in the entire burst
   If it receives a burst of many messages from the network, and then receives a “catastrophic error” message from the attached device before forwarding all the packets to the attached device, it then flushes the buffer, ignoring all the remaining packets in the device, and sends back to the network only the single error packet rather than all the individual acknowledgements.
   It combines acknowledgement packets. So rather than sending a separate acknowledgement for each packet in the burst, it waits until it receives all the acknowledgements from the attached device, then sends just a single, higher-level acknowledgement back to the network.
   If there are timing problems, it can speed up or slow down its traffic in both directions to deal with those problems and increase reliability.
   In case of very severe errors, it takes actions on its own:
      If the attached device is a door, the WiFi modem can send the door a packet to put it in “lockdown mode” (where even legitimate users are not allowed to unlock it).
      If the attached device is a camera, the WiFi modem could send it a signal to take a picture and store it internally, or could send that picture over the network
      If the attached device is a motion sensor that senses something, the WiFi modem could send an alarm back to a central monitoring station to alert it of the event.
      A remote control server could send the communication device rules for how to handle various events such as the above. This allows a single, mass-produced communication device to embody the intelligence so that the attached device can be simpler and cheaper.
         There are several extension to the invention:
Instead of WiFi some other wireless protocol, such as Zigbee, WiMax, are also encompassed by the invention.
The invention can apply to other communication systems such as an optical fiber system. The point is that the network connection over a distance uses more energy than the local, serial connection.

The methods described herein can be implemented as computer-readable instructions stored on a computer-readable storage medium that when executed by a computer will perform the methods described herein.

Note that in some embodiments, it may be possible to replace the transceiver with just a receiver since the remote device may not always need to communicate with the control point.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A low power wireless communication method, comprising the steps of:
determining if an aperiodic event has occurred at a remote device;
when the aperiodic event has occurred, listening for a message waiting signal from a control point; and
when a message waiting signal is received, transmitting an acknowledge signal to the control point.

2. The method of claim 1, wherein the step of determining if an aperoidic event includes the step of calculating a random time interval.

3. The method of claim 1, wherein the step of determining if an aperoidic event includes the step of detecting an event.

4. The method of claim 1, further including the step of when the aperiodic event has not occurred, turning off a receiver at the remote device.

5. The method of claim 1, further including the step of when the message waiting signal is not received, turning off a receiver at the remote device.

6. The method of claim 1, wherein the step of listening includes the step of listening for a predetermined period of time and if the message waiting signal has not been received, turning off a receiver at the remote device.

7. A low power wireless communication method, comprising the steps of:
listening for a wake-up signal at a simple receiver of a remote device; and
when the wake-up signal is received, turning on a complex receiver at the remote device.

8. The method of claim 7, wherein the step of listening includes the step of detecting a specific frequency signal.

9. The method of claim 7, further including the step of listening with the complex receiver for a message from a control device.

10. The method of claim 9, further including the step of when the message is not received with a predetermined period of time, turning off the complex receiver.

11. The method of claim 7, wherein the step of listening includes the step of determining if an event has occurred.

12. The method of claim 11, wherein the step of determining if the event has occurred includes detecting an aperiodic event.

13. The method of claim 7, further including the step of transmitting an awake signal from the complex receiver.

14. The method of claim 12, wherein the step of detecting an aperiodic event includes the step of calculating a random time.

15. A low power wireless communication method, comprising the steps of:
selecting one of a plurality of data transfer modes between a wireless modem and a device;
when a low power pass-through data transfer mode is selected, storing an incoming message in a memory cache; and
transferring in a non-real time manner the incoming message from the memory cache to the device.

16. The method of claim 15, further including the step of when a high speed real-time data transfer mode is selected passing the incoming message in an essentially real-time manner to the device.

17. The method of claim 15, further including the steps of when a low power filtered transfer mode is selected, storing the incoming message in the memory cache and then analyzing the incoming message.

18. The method of claim, 17 further including the step, when the incoming message is not required by the device, not transmitting the message to the device.

19. The method of claim 15, wherein the step of selecting further includes the steps of:
determining if an aperiodic event has occurred at the wireless modem;
when an aperiodic event has occurred, listening for a message waiting signal from a control point; and
when a message waiting signal is received, transmitting an acknowledge signal to the control point.

20. The method of claim 15, wherein the step of selecting further includes the steps of:
listening for a wake-up signal at a simple receiver of the wireless modem; and
when the wake-up signal is received, turning on a complex receiver at the wireless modem.
